(19) United States
(12) Patent Application Publication
(10) Pub. No.: US 2024/0059868 A1
(43) Pub. Date: Feb. 22, 2024

(54) RUBBER COMPOSITION

(71) Applicant: Compagnie Generale des Etablissements Michelin, Clermont-Ferrand (FR)

(72) Inventor: Xiaofeng Shaw YANG, Simpsonville, SC (US)

(21) Appl. No.: 18/259,349

(22) PCT Filed: Dec. 28, 2020
(86) PCT No.: PCT/US20/67100

§ 371 Date: Jun. 26, 2023

(51) Int. Cl. C08K 5/18; C08K 3/04; C08K 3/36; C08L 7/00; C08K 3/06

(52) U.S. Cl. CPC C08K 5/18; C08K 3/04; C08K 3/36; C08L 7/00; C08K 3/06; C08K 2201/006

(57) ABSTRACT

A rubber composition is disclosed and more particularly, a rubber composition having low uncured viscosity for better green rubber handling and high cured cohesiveness desired cured article properties, methods for making them and articles made from such rubber compositions. Particularly the invention uses 3-hydroxydiphenylamine or 4-hydroxydiphenylamine or their combinations in a rubber composition yielding a rubber composition having a low uncured viscosity for rubber processing and a high cured cohesion and rigidity for the cured rubber product. Such a composition is particularly suitable for rubber applications including tires.

### FIELD OF THE INVENTION

This invention relates generally to rubber compositions and more particularly, to rubber compositions having low uncured viscosity and high cured cohesiveness, methods for making them and articles made from such rubber compositions. Particularly the invention uses 3-hydroxydiphenylamime or 4-hydroxydiphenylamine or their combinations in a rubber composition yielding a rubber composition having a low uncured viscosity for rubber processing and a high cured cohesion and rigidity for the cured rubber product.

### BACKGROUND OF THE INVENTION

Tires and other articles that are made of rubber are manufactured from rubber compositions that include rubber, e.g., natural rubber, synthetic rubber or combinations thereof, reinforcing fillers, vulcanizing agents, and other components that improve the physical mechanical characteristics of both the uncured and the cured rubber compositions.

Typically, a reasonably low uncured viscosity of the rubber composition is required for processing or forming before the rubber is cured, such as in tires. On the other hand, some predefined rigidities and acceptable cohesive properties at the cured state are critical for the performances of the rubber goods such as in tire treads, beads, and sidewalls.

For rubber compounders, it is often a compromise to compound rubbers with low viscosity at uncured state for processing while still being able to offer reasonable rigidity and high cohesion at cured state. Those skilled in the art understand that there are different ways of minimizing the uncured viscosity at processing conditions, for example, by adding plasticizers such as petroleum derived oils and low molecular weight resins. However, and as is often the case, the addition of such plasticizers can result in some degradations or compromises in rubber's cured rigidity and cohesive properties. Therefore, rubber compounders strive to search for ways to reduce rubber's uncured viscosity without significant impact on rubber's cured characteristics, or even better, to reduce uncured viscosity and in the meanwhile improve cured properties.

The use of 3- or 4-HDPA in rubber compositions have been reported to improve the rubber's physical properties, as shown above; however, all these rubber compositions require the use of a methylene donor such as hexamethylenetetramine or hexamethoxymethylmelamine to harden HDPA. For example,

U.S. Pat. No. 6,541,551 discloses a vulcanizable rubber composition comprising a rubber component, a methylene donor, and a methylene acceptor selected from the group consisting of substituted or unsubstituted 3-hydroxydiphenylamine.

U.S. Pat. No. 9,279,044 discloses a rubber composition comprising a diene elastomer, a reinforcing filler, a methylene donor, a first methylene acceptor selected from 3-hydroxydiphenylamine, 4-hydroxydiphenylamine or combinations thereof, and a second methylene acceptor selected from a novolac resin, diphenylolmethane, diphenylolethane diphenylolpropane, diphenylolbutane, a naphthol, a cresol or combinations thereof.

CN101649079 discloses a rubber composition comprising a rubber selected from natural rubber or synthetic rubber, a methylene donor, and a blend of resorcinol and m-aminophenol derivative as the methylene acceptor.

U.S. Pat. No. 9,518,165 discloses a tire rubber component and a method for the same, comprising a diene elastomer, a reinforcing filler, a methylene donor, a methylene acceptor selected from 3-hydroxydiphenylamine, 4-hydroxydiphenylamine and combinations thereof, wherein the ratio of the methylene acceptor to the methylene donor is at least 15:1.

None of the prior publications improve industrial processability of the green rubber mix while improving the cured rubber's physical properties without the use of a methylene donor such as hexamethylenetetramine or hexamethoxymethylmelamine. A need exists for an improved rubber mix that reduces the uncured viscosity and increases the cohesiveness of the cured rubber without significantly affecting the cured rubber rigidity.

### SUMMARY OF THE INVENTION

Aspects and advantages of the invention will be set forth in part in the following description, or may be obvious from the description, or may be learned through practice of the invention. Particular embodiments of the present invention include rubber compositions, articles made from such rubber compositions, and the methods for making the same.

Such embodiments include a tire component; the tire component comprising a rubber composition that is based upon a cross-linkable elastomer composition, the cross-linkable elastomer composition comprising, per 100 parts by weight of rubber (phr), a highly unsaturated diene elastomer, a reinforcing filler, and a property modifier selected from 3-hydroxydiphenylamine, 4-hydroxydiphenylamine or combinations thereof. Furthermore, such rubber compositions do not include any methylene donor.

Methods that are embodiments of the present invention include methods for manufacturing a tire component, such methods comprising mixing together components of a rubber composition into a non-productive mix, the components including a highly unsaturated diene elastomer, a reinforcing filler, and a property modifier selected from 3-hydroxydiphenylamine, 4-hydroxydiphenylamine or combinations thereof. Such methods may further include cooling the non-productive mix and mixing a vulcanizing agent into the non-productive mix to convert the non-productive mix to a productive mix. In particular embodiments, the method may further include forming the tire component from the productive mix.

These and other features, aspects and advantages of the present invention will become better understood with reference to the following description and appended claims. The accompanying—examples, which are incorporated in and constitute a part of this specification, illustrate embodiments of the invention and, together with the description, serve to explain the principles of the invention.

### DETAILED DESCRIPTION OF THE INVENTION

The present invention pertains to a rubber composition having a low uncured viscosity and high cured cohesiveness. For purposes of describing the invention, reference now will be made in detail to embodiments and/or methods of the invention. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

Particular embodiments of the present invention include rubber compositions that have a component selected from 3-hydroxydiphenylamine (3-HDPA), 4-hydroxydiphenylamine (4-HDPA) or combinations thereof; but the rubber compositions will have no methylene donor such as hexamethylenetetramine or hexamethoxymethylmelamine.

Surprisingly, it has been discovered that the addition of HDPA not only reduced uncured viscosity as measured by Mooney, but also increased the cohesiveness as represented by elongational strain at break and tearing strain at break; while such addition did not reduce the cured rigidity as measured by MA10 modulus.

Typically, the loading of HDPA is in the range of 0.5 to 10 phr. The HDPA should be added in the non-productive mix.

Reference will now be made in detail to embodiments of the invention, provided by way of explanation of the invention. For example, features illustrated or described as part of one embodiment can be used with another embodiment to yield still a third embodiment. It is intended that the present invention include these and other modifications and variations.

Elastomers: highly unsaturated diene elastomers include NR, IR, SBR, BR, IIR and any combinations thereof.

The rubber elastomers suitable for use with particular embodiments of the present invention include highly unsaturated diene elastomers, for example, polybutadiene rubber (BR), polyisoprenes (IR), natural rubber (NR), butadiene copolymers, isoprene copolymers and mixtures of these elastomers. The polyisoprenes include synthetic cis-1,4 polyisoprene, which may be characterized as possessing cis-1,4 bonds at more than 90 mol. % or alternatively, at more than 98 mol. %. Particular embodiments of the disclosed rubber compositions include only natural rubber.

Also suitable for use in particular embodiments of the present invention are rubber elastomers that are copolymers and include, for example, butadiene-styrene copolymers (SBR), butadiene-isoprene copolymers (BIR), isoprene-styrene copolymers (SIR) and isoprene-butadiene-styrene copolymers (SBIR) and mixtures thereof.

The elastomer system may be a blend of various elastomers with a total of 100 phr.

Reinforcing fillers: Carbon black, which is an organic filler, is well known to those having ordinary skill in the rubber compounding field. The carbon black included in the rubber compositions produced by the methods disclosed herein may, in particular embodiments for example, be in an amount of between 20 phr and 150 phr or alternatively between 40 phr and 100 phr or between 40 phr and 80 phr. Suitable carbon blacks are any carbon blacks known in the art and suitable for the given purpose for example, any carbon black having a BET surface area or a specific CTAB surface area both of which are less than 400 m2/g or alternatively, between 20 and 200 m2/g may be suitable for particular embodiments based on the desired properties of the cured rubber composition. The CTAB specific surface area is the external surface area determined in accordance with Standard AFNOR-NFT-45007 of November 1987. Suitable carbon blacks of the type HAF, ISAF and SAF, for example, are conventionally used in tire treads. Non-limitative examples of carbon blacks include, for example, the N115, N134, N234, N299, N326, N330, N339, N343, N347, N375 and the 600 series of carbon blacks, including, but not limited to N630, N650 and N660 carbon blacks.

As noted above, silica may also be useful as reinforcement filler. The silica may be any reinforcing silica known to one having ordinary skill in the art including, for example, any precipitated or pyrogenic silica having a BET surface area and a specific CTAB surface area both of which are less than 450 m2/g or alternatively, between 20 and 400 m2/g may be suitable for particular embodiments based on the desired properties of the cured rubber composition. Particular embodiments of rubber compositions disclosed herein may include a silica having a CTAB of between 80 and 200 m2/g, between 100 and 190 m2/g, between 120 and 190 m2/g or between 140 and 180 m2/g.

When silica is added to the rubber composition, a proportional amount of a silane coupling agent is also added to the rubber composition. The silane coupling agent is a sulfur-containing organosilicon compound that reacts with the silanol groups of the silica during mixing and with the elastomers during vulcanization to provide improved properties of the cured rubber composition. A suitable coupling agent is one that is capable of establishing a sufficient chemical and/or physical bond between the inorganic filler and the diene elastomer; which is at least bifunctional, having, for example, the simplified general formula “Y-T-X”, in which: Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica); X represents a functional group (“X” function) which is capable of bonding physically and/or chemically with the diene elastomer, for example by means of a sulfur atom; T represents a divalent organic group making it possible to link Y and X.

Plasticizers: oils, resins (from petroleum or other natural renewable resources, e.g., sunflower seeds, citrus orange peels).

Processing oils are well known to one having ordinary skill in the art, are generally extracted from petroleum and are classified as being paraffinic, aromatic or naphthenic type processing oil, including MES and TDAE oils. Processing oils are also known to include, inter alia, plant-based oils, such as sunflower oil, rapeseed oil and vegetable oil. Some of the rubber compositions disclosed herein may include an elastomer, such as a styrene-butadiene rubber, that has been extended with one or more such processing oils but such oil is limited in the rubber composition of particular embodiments as being no more than 10 phr of the total elastomer content of the rubber composition.

Vulcanization system: The vulcanization system is preferably, for particular embodiments, one based on sulfur and on an accelerator but other vulcanization agents known to one skilled in the art may be useful as well. Vulcanization agents as used herein are those materials that cause the cross-linkage of the rubber and therefore may be added only to the productive mix so that premature curing does not occur. Such agents including, for example, elemental sulfur, sulfur donating agents, and peroxides. Use may be made of any compound capable of acting as an accelerator of the vulcanization of elastomers in the presence of sulfur, in particular those chosen from the group consisting of 2-mercaptobenzothiazyl disulfide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-tert-butyl-2-benzothiazolesulphenamide (abbreviated to “TBBS”), N-tert-butyl-2-benzothiazole-sulphenimide (abbreviated to “TBSI”) and the mixtures of these compounds. Preferably, a primary accelerator of the sulfenamide type is used.

The rubber composition may also include vulcanization retarders, a vulcanization system based, for example, on sulfur or on a peroxide, vulcanization accelerators, vulcanization activators, and so forth.

The vulcanization system may further include various known secondary accelerators or vulcanization activators, such as zinc oxide, stearic acid and guanidine derivatives (in particular diphenylguanidine).

Other components: The rubber compositions disclosed herein may further include, in addition to the compounds already described, all or part of the components often used in diene rubber compositions intended for the manufacture of tires, such as, pigments, protective agents of the type that include antioxidants and/or antiozonants, such as 6PPD, 7PPD, TMQ, hindered phenol, and wax. There may also be added, if desired, one or more conventional non-reinforcing fillers such as clays, bentonite, talc, chalk kaolin, aluminosilicate, fiber, or coal.

### Mixing and Production:

The rubber compositions that are embodiments of the present invention may be produced in suitable mixers in a manner known to those having ordinary skill in the art. Typically the mixing may occur using two successive preparation phases, a first phase of thermo-mechanical working at high temperature followed by a second phase of mechanical working at a lower temperature.

The rubber compositions that are embodiments of the present invention may be produced in suitable mixers in a manner known to those having ordinary skill in the art. Typically the mixing may occur using two successive preparation phases, a first phase of thermo-mechanical working at high temperature followed by a second phase of mechanical working at a lower temperature.

The first phase, sometimes referred to as a “non-productive” phase, includes thoroughly mixing, typically by kneading, the various ingredients of the composition but excluding some of the vulcanization system such as the vulcanization agents, the accelerators, and the retarders. It is carried out in a suitable kneading device, such as an internal mixer of the Banbury type, until under the action of the mechanical working and the high shearing imposed on the mixture, a maximum temperature of generally between 120° C. and 190° C. is reached, indicating that the components are well dispersed.

After cooling the mixture a second phase of mechanical working is implemented at a lower temperature. Sometimes referred to a “productive” phase, this finishing phase consists of incorporating some of the aforementioned vulcanization system that were not added in the “non-productive” phase, including the vulcanization agents, the accelerators, and the retarders into the rubber composition using a suitable device, such as an open mill. It is performed for an appropriate time (typically, for example, between 1 and 30 minutes or between 2 and 10 minutes), and at a sufficiently low temperature, i.e., lower than the vulcanization temperature of the mixture, so as to protect against premature vulcanization.

The rubber composition can be formed into useful articles, including tire components. Tire treads, for example, may be formed as tread bands and then later made a part of a tire or they be formed directly onto a tire carcass by, for example, extrusion and then cured in a mold. Other components such as those located in the bead area of the tire or in the sidewall may be formed and assembled into a green tire and then cured with the curing of the tire.

The invention is further illustrated by the following examples, which are to be regarded only as illustrations and not delimitative of the invention in any way. The properties of the compositions disclosed in the examples were evaluated as described below.

Uncured viscosity and testing: Industrially, Mooney viscosity ML1+4 is used as an indicator for processability such as in extrusion, calendaring and other forming techniques. Mooney viscosity (ML 1+4) was measured in accordance with ASTM Standard D1646. In general, the composition in an uncured state is molded in a cylindrical enclosure and heated to 100° C. After 1 minute of preheating, the rotor turns within the test sample at 2 rpm, and the torque used for maintaining this movement is measured after 4 minutes of rotation. The Mooney viscosity is expressed in “Mooney units” (MU, with 1 MU=0.83 Newton-meter). In general, the lower the Mooney viscosity, the easier the uncured products are to be processed.

Cured properties and testing: tire performance related indicators with detailed descriptions:

Rigidity MA 10: Rigidity MA10 or modulus of elongation (MPa) was measured at 10% elongation (MA10) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

Break stress, force at breaking and Break strain, elongation at breaking: The elongation property was measured as elongation at break (%) and the corresponding elongation stress (MPa), which is measured at 23° C. in accordance with ASTM Standard D412 on ASTM C test pieces.

Tearing stress, DZ force at tearing and Tearing strain, DZ elongation at tearing: Tear properties were measured on test samples cut from a cured plaque with a thickness of approximately 2.5 mm Notches (perpendicular to the test direction) were created in the samples prior to testing. The force and elongation at break was measured using an Instron 5565 Uniaxial Testing System. The cross-head speed was 500 mm/min Samples were tested at 23° C.

### EXAMPLES

The invention is further illustrated by the following examples, which are to be regarded only as illustrations and not delimitative of the invention in any way. The properties of the compositions disclosed in the examples were evaluated as described above.

### Example 1. 1/3/5/8 Phr 3HDPA in Carbon Black Filled NR Formulations

This example illustrates the surprising increases in the elongational and tearing cohesiveness as well as the decrease in Mooney viscosity in accordance with the present invention. The following table showed the formulas and properties in a 100NR/N347 formulation, where W1-1 and W1-2 represented the references without and with 5 phr napthenic oil, respectively, and F1-1, F1-2, F1-3, and F1-4 represented this invention with 1, 3, 5, and 8 phr 3HDPA, respectively.

| Examples | W1-1 | W1-2 | F1-1 | F1-2 | F1-3 | F1-4 |
|---|---|---|---|---|---|---|
| Constituents | | | | | | |
| NR | 100 | 100 | 100 | 100 | 100 | 100 |
| Carbon black N347 | 55 | 55 | 55 | 55 | 55 | 55 |
| 6PPD | 2 | 2 | 2 | 2 | 2 | 2 |
| Napthenic oil | | 5 | | | | |
| 3HDPA | | | 1 | 3 | 5 | 8 |
| SAD | 2 | 2 | 2 | 2 | 2 | 2 |
| ZNO | 3 | 3 | 3 | 3 | 3 | 3 |
| CBS | 1 | 1 | 1 | 1 | 1 | 1 |
| S | 2 | 2 | 2 | 2 | 2 | 2 |
| Uncured properties | | | | | | |
| Mooney viscosity at 100° C. | 83.5 | 71.2 | 79.4 | 76.3 | 74.6 | 69.0 |
| curing time at 150° C., min | 20 | 20 | 20 | 20 | 20 | 20 |
| Cured properties at 23° C. | | | | | | |
| MA10, MPa | 6.4 | 5.5 | 6.6 | 7.4 | 7.6 | 8.3 |
| MA100, MPa | 3.3 | 2.8 | 3.1 | 2.8 | 2.2 | 1.8 |
| Elongational break stress, MPa | 27 | 28 | 27 | 26 | 23 | 21 |
| Elongational break strain, % | 323 | 368 | 364 | 391 | 427 | 433 |
| DZ tear stress, MPa | 59 | 57 | 82 | 107 | 100 | 72 |
| DZ tear strain, % | 134 | 145 | 179 | 257 | 282 | 276 |

As can be seen, compared to the no-oil formula W1-1, oil addition in W1-2 did reduce the green Mooney viscosity without significant impact on the cured breaking and tearing properties; however, oil addition also reduced the cured MA10 rigidity.

Surprisingly, according to this invention in F1-1, F1-2, F1-3, and F1-4, the addition of 1 to 8 phr 3HDPA not only reduced the Mooney viscosities, though not to the same extend as oil at the same phr loading, it also at least retained or even increased the MA10 rigidities. More surprisingly, and depending on its loading, 3HDPA significantly improved the elongational and tearing properties.

As an example, compared to the no-oil composition W1-1, 5 phr 3HDPA reduced Mooney from 83.5 to 74.6 without reducing cured rigidity MA10; and more surprisingly, it even increased the break strain and tear strain from 323% to 427% and 134% to 282%, respectively.

On the other hand, if the comparison is made between the oil and the 3HDPA at the same 5 phr loadings, though the Mooney with 3HDPA was slightly higher than with oil, 74.6 and 71.2 respectively, the MA10 rigidity with 3HDPA was higher than with oil, 5.5 and 7.6 respectively. More surprisingly, even at higher MA10 rigidity, the tearing strain with 3HDPA was almost doubled as with oil, 282% and 145% respectively.

### Example 2. HDPA in SBR and NR/SBR Blends, Black Filled Systems

The following table demonstrates the benefits of 3HDPA in a 100 phr SBR and a 50/50 phr blend of SBR and NR formulations. Again, it is surprising to observe that the addition of 5 phr 3HDPA not only reduced the uncured viscosities in both the 100SBR and 50NR/50SBR cases, but also improved the cured cohesive properties without reducing cured rigidities.

| | W2-1 | W2-2 | F2 | W3-1 | W3-2 | F3 |
|---|---|---|---|---|---|---|
| Constituents | | | | | | |
| NR | | | | 50 | 50 | 50 |
| SBR | 100 | 100 | 100 | 50 | 50 | 50 |
| Carbon black N347 | 55 | 55 | 55 | 55 | 55 | 55 |
| 6PPD | 2 | 2 | 2 | 2 | 2 | 2 |
| Napthenic oil | | 5 | | | 5 | |
| 3HDPA | | | 5 | | | 5 |
| SAD | 2 | 2 | 2 | 2 | 2 | 2 |
| ZNO | 3 | 3 | 3 | 3 | 3 | 3 |
| CBS | 1 | 1 | 1 | 1 | 1 | 1 |
| S | 2 | 2 | 2 | 2 | 2 | 2 |
| Uncured property | | | | | | |
| Mooney viscosity at 100° C. | 111.2 | 92.0 | 93.3 | 89.6 | 74.1 | 77.7 |
| curing time at 150° C., min | 60 | 60 | 60 | 20 | 20 | 20 |
| Cured properties at 23° C. | | | | | | |
| MA10, MPa | 7.2 | 6.2 | 7.4 | 6.9 | 5.9 | 7.2 |
| MA100, MPa | 3.7 | 3.1 | 2.4 | 3.5 | 3.0 | 2.1 |
| break stress, MPa | 24 | 24 | 21 | 26 | 25 | 22 |
| break strain, % | 278 | 323 | 464 | 316 | 347 | 478 |
| tear stress, MPa | 29 | 31 | 43 | 62 | 79 | 81 |
| tear strain, % | 79 | 98 | 165 | 146 | 194 | 304 |

### Example 3. HDPA in Silica Filled Elastomer

The following table showed the effect of HDPA on a silica based formulation. Again, it is surprising to find out that HDPA reduced uncured viscosity without significant impact on cured MA10 rigidity. On the other hand, it seemed that the improvement on the cohesive properties (elongational and tearing) in silica formulation was not as great as in carbon black filled systems.

| Examples | W4-1 | W4-2 | F4 |
|---|---|---|---|
| Constituents | | | |
| SBR | 100 | 100 | 100 |
| Silica 165G | 60 | 60 | 60 |
| Dry Silane (50/50 Si69/N330) | 12 | 12 | 12 |
| DPG | 1.2 | 1.2 | 1.2 |
| 6PPD | 2 | 2 | 2 |
| Napthenic oil | | 5 | |
| 3HDPA | | | 5 |
| SAD | 2 | 2 | 2 |
| ZNO | 3 | 3 | 3 |
| CBS | 1 | 1 | 1 |
| S | 2 | 2 | 2 |
| Uncured property | | | |
| Mooney viscosity at 100° C. | 118.6 | 97.6 | 106.5 |
| curing time at 150° C., min | 60 | 60 | 60 |
| Cured properties at 23° C. | | | |
| MA10, MPa | 9.5 | 7.3 | 9.4 |
| MA100, MPa | 3.8 | 3.2 | 3.2 |
| break stress, MPa | 22 | 20 | 21 |
| break strain, % | 279 | 283 | 311 |
| tear stress, MPa | 34 | 31 | 36 |
| tear strain, % | 86 | 95 | 108 |

### Example 4. 3HDPA Vs. 4HDPA

The differences between 3HDPA vs. 4HDPA on rubber properties are shown in the following table, indicating similar surprising results of reducing the green viscosity and improving cured cohesion without reducing MA10 rigidity, though it seemed 4HDPA was not as effective as 3HDPA in reducing the green viscosity.

| Examples | W5 | F5-1 | F5-2 |
|---|---|---|---|
| Constituents | | | |
| NR | 100 | 100 | 100 |
| Carbon black N326 | 55 | 55 | 55 |
| SAD | 2 | 2 | 2 |
| ZNO | 3 | 3 | 3 |
| S | 1.5 | 1.5 | 1.5 |
| TBBS | 1.5 | 1.5 | 1.5 |
| 3HDPA | | 5 | |
| 4HDPA | | | 5 |
| Uncured property | | | |
| Mooney viscosity at 100° C. | 91.8 | 89.4 | 84.7 |
| Cured properties at 23° C. | | | |
| MA10, MPa | 7.4 | 9.2 | 8.7 |
| MA100, MPa | 3.8 | 2.3 | 3.0 |
| break stress, MPa | 28 | 28 | 29 |
| break strain, % | 397 | 560 | 494 |
| tear stress, MPa | 85 | 104 | 103 |
| tear strain, % | 181 | 305 | 248 |

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.” The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

The following is a replacement claim set:

1. A rubber composition that is based upon a cross-linkable elastomer composition comprising, per 100 parts by weight of rubber (phr):
a highly unsaturated diene elastomer;
a reinforcing filler, selected from carbon blacks, silicas, or combination thereof.
a modifier consisting of a hydroxydiphenylamine and not containing any methylene donor.

2. The rubber composition of claim 1 wherein the highly unsaturated diene elastomers is selected from the group consisting of natural rubber (NR), isoprene rubber (IR), styrene-butadiene rubber (SBR), butyl rubber (BR), isobutylene-isoprene rubber (IIR) and combinations thereof.

3. (canceled)

4. The rubber composition of claim 2 wherein the reinforcing filler carbon black of 20-400 m2/g surface area is present in an amount of no less than 20 phr.

5. The rubber composition of claim 2 wherein the reinforcing filler silicas of 20-400 m2/g surface area is present in an amount no less than 20 phr.

6. The rubber composition of claim 5 wherein the modifier is selected from a group consisting of 3-hydroxydiphenylamine, 4-hydroxydiphenylamine, and combinations thereof.

7. The rubber composition of claim 5 wherein the total hydroxydiphenylamine loading is in the range of 0.5 to 10 phr.

8. The rubber composition of claim 7 wherein the total reinforcing filler loading is in the range of between 30 phr and 150 phr.

9. The rubber composition of claim 8 wherein the total reinforcing filler loading is in the range of between 40 phr and 100 phr.

10. The rubber composition of claim 9 wherein the total reinforcing filler loading is in the range of between 40 phr and 80 phr.

11. The rubber composition of claim 5 further comprising:
a vulcanization agent chosen from the group consisting of sulfur, sulfur donating agents, peroxides, combinations thereof; and
an antioxidant and or antiozonant chosen from the group consisting of 6PPD, 7PPD, TMQ, hindered phenol, wax or combinations thereof.

12. The rubber composition of claim 11 further comprising a plasticizer chosen from the group consisting of oils, resins, and combinations thereof.

13. The rubber composition of claim 11 further comprising vulcanization modifiers chosen from the group consisting of accelerators, retarders and combinations thereof.

14. A tire comprised of the rubber composition of any one of the above claims.

15. The rubber composition of claim 1 further comprising:
a vulcanization agent chosen from the group consisting of sulfur, sulfur donating agents, peroxides, combinations thereof; and
an antioxidant and or antiozonant chosen from the group consisting of 6PPD, 7PPD, TMQ, hindered phenol, wax or combinations thereof.

16. The rubber composition of claim 15 wherein the highly unsaturated diene elastomers is selected from the group consisting of natural rubber (NR), isoprene rubber (IR), styrene-butadiene rubber (SBR), butyl rubber (BR), isobutylene-isoprene rubber (IIR) and combinations thereof.

17. The rubber composition of claim 15 wherein the modifier is selected from a group consisting of 3-hydroxydiphenylamine, 4-hydroxydiphenylamine, and combinations thereof.

18. The rubber composition of claim 15 wherein the total hydroxydiphenylamine loading is in the range of 0.5 to 10 phr.

19. The rubber composition of claim 15 wherein the total reinforcing filler loading is in the range of between 30 phr and 150 phr.

20. The rubber composition of claim 15 wherein the total reinforcing filler loading is in the range of between 40 phr and 100 phr.

21. The rubber composition of claim 15 wherein the total reinforcing filler loading is in the range of between 40 phr and 80 phr.
